(19) United States
(12) Patent Application Publication
(10) Pub. No.: US 2024/0144146 A1
(43) Pub. Date: May 2, 2024

(54) CARBON FOOTPRINT SIZING FOR CLOUD SOLUTIONS

(71) Applicant: SAP SE, Walldorf (DE)

(72) Inventors: Detlef THOMS, Rastatt (DE); Rudolf Meier, Walldorf (DE)

(21) Appl. No.: 17/977,522

(22) Filed: Oct. 31, 2022

(51) Int. Cl. G06Q 10/06; G06F 9/50

(52) U.S. Cl. CPC G06Q 10/06393; G06F 9/5094; G06F 2209/501; G06F 2209/5019

(57) ABSTRACT

Example methods and systems are directed to carbon footprint sizing for cloud solutions. An account of the cloud solution provides information related to the expected usage of the cloud solution (e.g., a number of users, a number of processes to be performed, or both). Based on the information, an amount of computing resources (e.g., a number of processor cores, an amount of memory, networking resources, or any suitable combination thereof) to be used for the account is determined. The amount of computing resources is used in conjunction with data about available computing devices to assign computing devices to the account. The carbon emission for the assigned computing devices may be determined based on the power consumption of the computing device, the power usage efficiency of a data center housing the computing device, and a carbon emission intensity for the energy source that provides power to the data center.

### TECHNICAL FIELD

The subject matter disclosed herein generally relates to determining carbon production from electricity consumption. Specifically, the present disclosure addresses systems and methods to size carbon footprints for cloud solutions.

### BACKGROUND

Electricity generation by the burning of fossil fuels emits atmospheric carbon. Thus, the use of computers that use electricity generated from fossil fuels indirectly generates carbon.

Cloud computing provides computer system resources, such as data storage and computing power, managed by a cloud services provider. Cloud-based applications provide software services running on cloud computing resources to remote users.

### BRIEF DESCRIPTION OF THE DRAWINGS

Some embodiments are illustrated by way of example and not limitation in the figures of the accompanying drawings.

FIG. 1 is a network diagram illustrating a network environment suitable for carbon footprint sizing cloud solutions, according to some example embodiments.

FIG. 2 is a block diagram of a carbon footprint server, according to some example embodiments, suitable for carbon footprint sizing cloud solutions, according to some example embodiments.

FIGS. 3-4 are block diagrams of a database schema, according to some example embodiments, suitable for use in carbon footprint sizing cloud solutions.

FIG. 5 illustrates graphs of power consumption for a server as a function of the Central Processing Unit (CPU) and memory usage, suitable for use in carbon footprint sizing cloud solutions according to some example embodiments.

FIG. 6 is a block diagram of a user interface suitable for carbon footprint sizing cloud solutions, according to some example embodiments.

FIG. 7 is a block diagram of a user interface suitable for carbon footprint sizing cloud solutions, according to some example embodiments.

FIG. 8 is a flowchart illustrating operations of a method suitable for carbon footprint sizing cloud solutions, according to some example embodiments.

FIG. 9 is a block diagram showing one example of a software architecture for a computing device.

FIG. 10 is a block diagram of a machine in the example form of a computer system within which instructions may be executed for causing the machine to perform any one or more of the methodologies discussed herein.

### DETAILED DESCRIPTION

Example methods and systems are directed to carbon footprint sizing for cloud solutions. A carbon footprint for an activity is a measure of the amount of carbon dioxide emissions caused by the activity. A cloud solution is an application or service provided by cloud computing. Cloud computing causes carbon dioxide emissions, at least in part, due to the release of carbon dioxide into the atmosphere when burning fossil fuels to generate electricity to power data centers.

An account of the cloud solution provides information related to the expected usage of the cloud solution (e.g., a number of users, a number of processes to be performed, or both). The account may be for an individual or for an organization (e.g., a business, government, or non-profit organization). Based on the information, an amount of computing resources (e.g., a number of processor cores, an amount of memory, networking resources, or any suitable combination thereof) to be used for the account is determined. The amount of computing resources is used in conjunction with data about available computing devices to assign computing devices to the account.

The carbon emission for the assigned computing devices may be determined based on the power consumption of the computing device, the power usage efficiency of a data center housing the computing device, and a carbon emission intensity for the energy source that provides power to the data center. Thus, the carbon emission for a cloud solution for an account may be determined based on the computing devices used to provide the cloud solution.

The account may use multiple cloud solutions. An aggregate carbon footprint for the multiple cloud solutions may be provided to the account. The account may be enabled to select options that affect the carbon footprint. For example, the account may opt to avoid computing resources that are located in countries with higher carbon emission intensity. As another example, the account may opt to use computing resources in data centers that use only renewable energy.

When these effects are considered in aggregate, one or more of the methodologies described herein may obviate a need for certain efforts or resources that otherwise would be involved in carbon sizing cloud solutions. Computing resources used by one or more machines, databases, or networks may similarly be reduced. Examples of such computing resources include processor cycles, network traffic, memory usage, data storage capacity, power consumption, and cooling capacity.

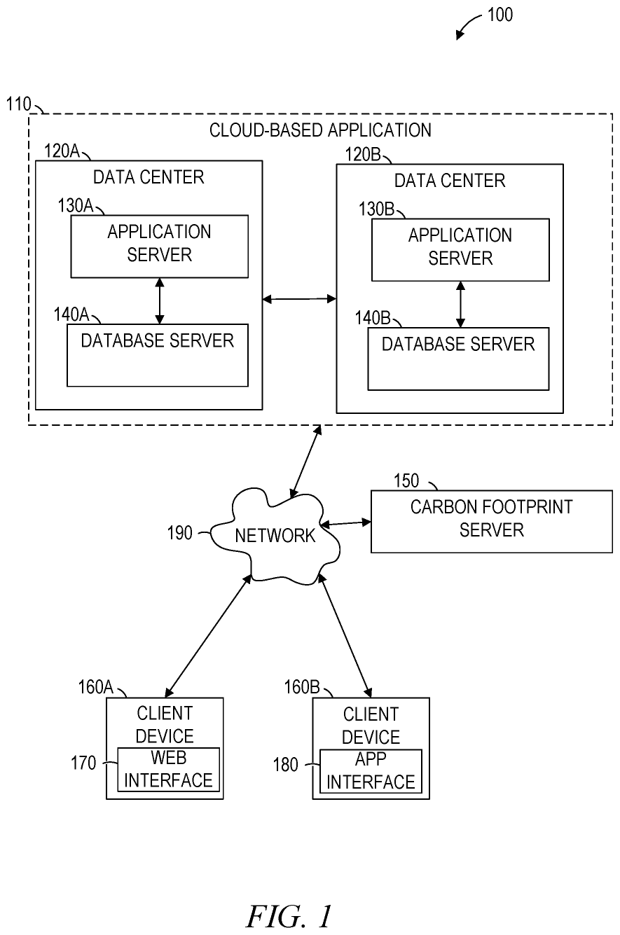

FIG. 1 is a network diagram illustrating a network environment 100 suitable for carbon footprint sizing cloud solutions, according to some example embodiments. The network environment 100 includes a cloud-based application 110, client devices 160A and 160B, and a network 190. The cloud-based application 110 is provided by application servers 130A and 130B in communication with database servers 140A and 140B. The application servers 130A-130B and the database servers 140A-140B are located in data centers 120A and 120B.

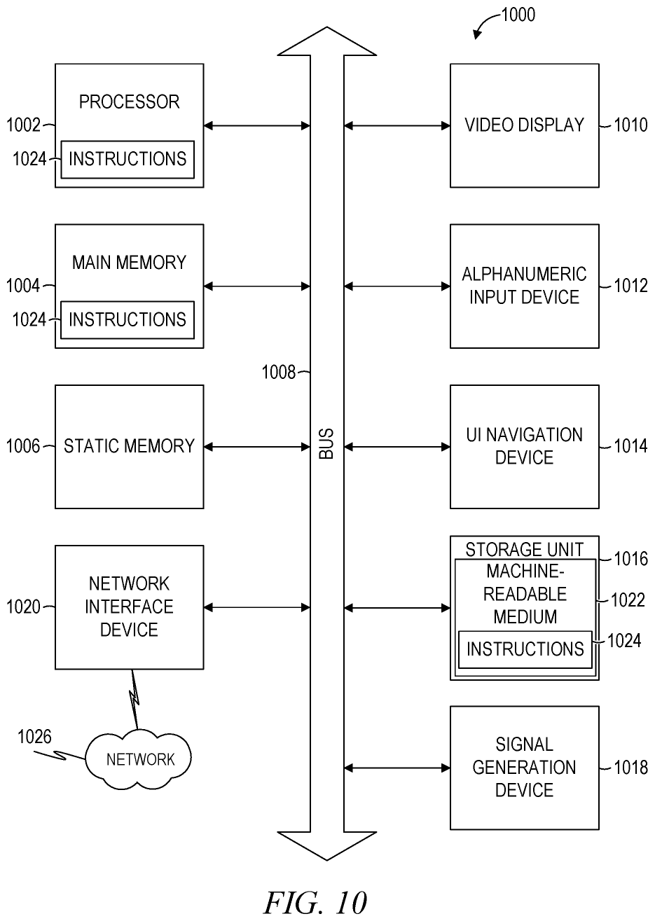

Reference numbers may be used without letter suffixes to refer to the corresponding components generically or in the aggregate. For example, “a client device 160” refers generically to either the client device 160A or the client device 160B and “the client devices 160” refers to the client devices 160A and 160B in the aggregate. By way of example and not limitation, FIG. 1 shows one cloud-based application 110, two data centers 120, two application servers 130, two database servers 140, and two client devices 160. In various implementations, multiple cloud-based applications 110 may be provided to any number of client devices 160 using any number of data centers 120, application servers 130, and database servers 140. The application servers 130, the database servers 140, the carbon footprint server 150, and the client devices 160A and 160B may each be implemented in a computer system, in whole or in part, as described below with respect to FIG. 10.

The application servers 130A-130B access application data (e.g., application data stored by the database servers 140A-140B) to provide one or more applications to the client devices 160A and 160B via a web interface 170 or an application interface 180. For example, the application server 130A may provide a support application that receives help requests from the client devices 160, routes each help request to a service account based on the content of the help request, receives responses from the service accounts, and sends the response to each help request to the requesting client device 160.

The carbon footprint server 150 accesses data from one or more of the database servers 140, one or more of the client devices 160, or any suitable combination thereof. Using the accessed data, the carbon footprint server 150 determines which computing devices will be used to provide the cloud-based application 110 to an account. Based on the determined computing devices and power consumption data for the determined computing devices, the carbon footprint server 150 determines a power consumption for providing the cloud-based application 110 to the account. Based on the power consumption and a carbon efficiency for the data center 120 for each computing device (e.g., the application servers 130) used to provide the cloud-based application 110 to the account, the carbon footprint server 150 determines a carbon footprint resulting from providing the cloud-based application 110 to the account. Carbon footprints for multiple cloud-based applications 110 for the account may be aggregated to determine a total carbon footprint for an account from a cloud-based application provider.

Any of the machines, databases, or devices shown in FIG. 1 may be implemented in a general-purpose computer modified (e.g., configured or programmed) by software to be a special-purpose computer to perform the functions described herein for that machine, database, or device. For example, a computer system able to implement any one or more of the methodologies described herein is discussed below with respect to FIG. 10. As used herein, a “database” is a data storage resource and may store data structured as a text file, a table, a spreadsheet, a relational database (e.g., an object-relational database), a triple store, a hierarchical data store, a document-oriented NoSQL database, a file store, or any suitable combination thereof. The database may be an in-memory database. Moreover, any two or more of the machines, databases, or devices illustrated in FIG. 1 may be combined into a single machine, database, or device, and the functions described herein for any single machine, database, or device may be subdivided among multiple machines, databases, or devices.

The application servers 130, the database servers 140, the carbon footprint server 150, and the client devices 160 are connected by the network 190. The network 190 may be any network that enables communication between or among machines, databases, and devices. Accordingly, the network 190 may be a wired network, a wireless network (e.g., a mobile or cellular network), or any suitable combination thereof. The network 190 may include one or more portions that constitute a private network, a public network (e.g., the Internet), or any suitable combination thereof.

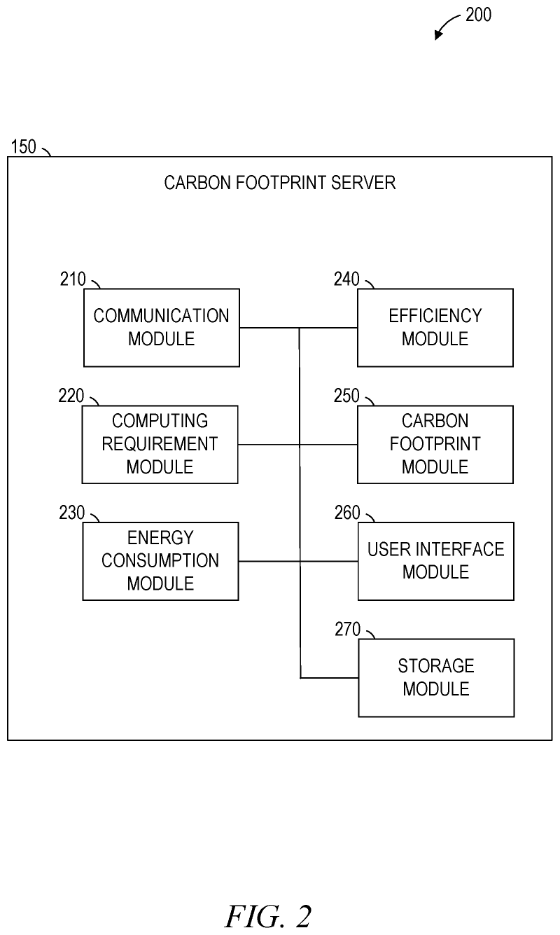

FIG. 2 is a block diagram 200 of a carbon footprint server 150, according to some example embodiments, suitable for carbon footprint sizing cloud solutions, according to some example embodiments. The carbon footprint server 150 is shown as including a communication module 210, a computing requirement module 220, an energy consumption module 230, an efficiency module 240, a carbon footprint module 250, a user interface module 260, and a storage module 270, all configured to communicate with each other (e.g., via a bus, shared memory, or a switch). Any one or more of the modules described herein may be implemented using hardware (e.g., a processor of a machine). For example, any module described herein may be implemented by a processor configured to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

The communication module 210 receives data sent to the carbon footprint server 150 and transmits data from the carbon footprint server 150. For example, the communication module 210 may receive, from the database server 140A, data indicating which application servers 130 are available in the data center 120A, the power consumption of those application servers 130, the number of CPU cores of those application servers 130, the power usage efficiency of the data center 120A, or any suitable combination thereof. As another example, the communication module 210 may receive, from the client device 160A, an indication of a number of users for the cloud-based application 110. The accessed data may be stored in local storage of the carbon footprint server 150 via the storage module 270. Communications sent and received by the communication module 210 may be intermediated by the network 190.

The computing requirement module 220 may operate on the accessed data to determine which application servers 130 will be used to provide the cloud-based application 110 to an account. Based on the determined application servers 130 and power consumption data for the determined application servers 130, the energy consumption module 230 determines the energy consumed by the computing resources providing the cloud-based application 110 to an account.

The determined energy consumption by the computing resources is converted to a total energy consumption in providing the cloud-based application 110 to the account by the efficiency module 240. For example, a data center 120 may consume power in providing lighting and air conditioning in addition to computing power. Accordingly, the actual power consumption in providing the cloud-based application 110 is greater than the power consumed directly by the computing resources.

The carbon footprint module 250 operates on the determined power consumption and data regarding carbon generation to determine the carbon footprint of the cloud-based application 110. The carbon footprint may be presented on a display device of the client device 160 (e.g., in the web interface 170 of the client device 160A).

A user interface may be provided by the user interface module 260. For example, the user interface module 260 may send, via the communication module 210, HTML files over the network 190 to the client device 160A. The web interface 170 (e.g., a web browser) of the client device 160A renders the user interface and sends data regarding user interactions with the user interface back to the user interface module 260.

The storage module 270 may store data locally on the carbon footprint server 150 (e.g., in a hard drive) or store data remotely. Examples of remote storage include network storage devices and the database servers 140.

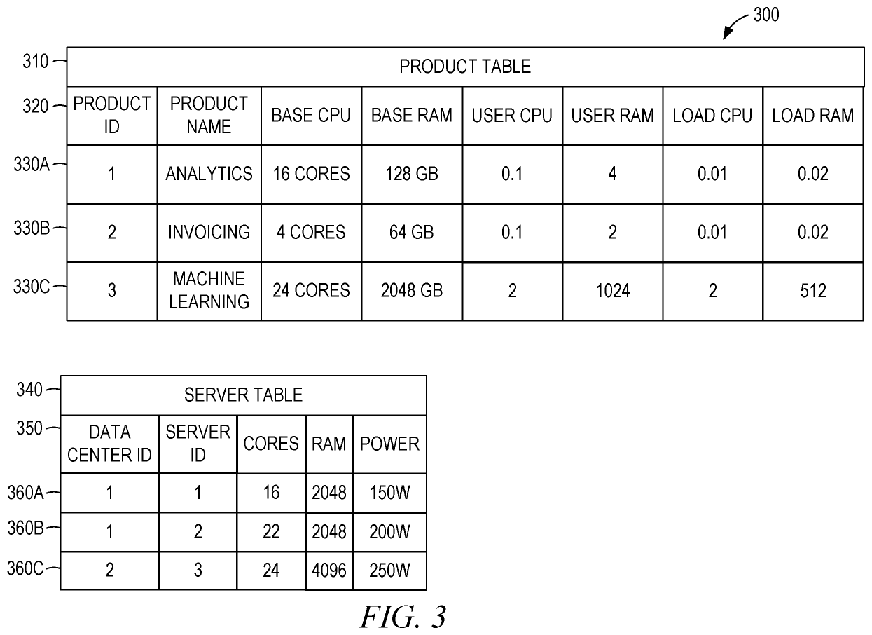

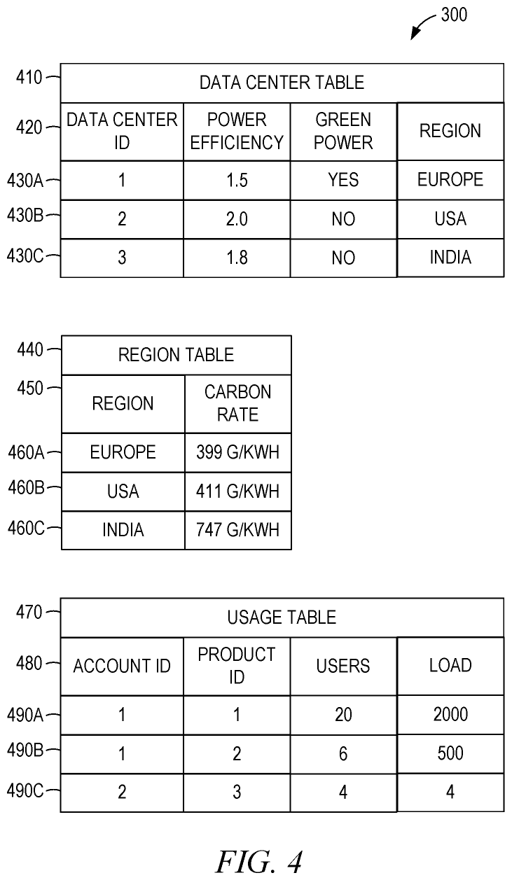

FIGS. 3-4 are block diagrams of a database schema 300, according to some example embodiments, suitable for use in carbon footprint sizing cloud solutions. The database schema 300 includes a product table 310, a server table 340, a data center table 410, and a region table 440. The product table 310 includes rows 330A, 330B, and 330C of a format 320. The server table 340 includes rows 360A, 360B, and 360C of a format 350. The data center table 410 includes rows 430A, 430B, and 430C of a format 420. The region table 440 includes rows 460A, 460B, and 460C of a format 450. The usage table 470 includes rows 490A, 490B, and 490C of a format 480. Though only a few rows are shown in each of the database tables 310, 340, 410, 440, 470, data for any number of products, servers, data centers, and regions may be stored in the database schema 300.

The format 320 of the product table 310 includes a product identifier field, a product name field, a base number of CPUs field, a base amount of Random Access Memory (RAM) field, a per-user number of CPUs field, a per-user amount of RAM field, a CPU load factor, and a RAM load factor. Each of the rows 330A-330C stores data for a single cloud-based application. The product identifier is a unique identifier for the application. Using the information in a row 330 of the product table 310 in combination with a number of users and a load for a cloud-based application, a number of CPU cores and an amount of memory to be used in providing the cloud-based application may be determined. The load for the cloud-based application is an indication of the intensity of the use of the application. For example, the load may be a number of documents per month to be processed by the cloud-based application for the account.

Each row 360 of the server table 340 includes a data center identifier, a server identifier, a number of CPU cores, an amount of RAM, and a power consumption, as defined by the format 350. Each of the rows 360A-360C stores data for a single computing device. The server identifier is a unique identifier for the computing device. The data center identifier identifies the data center 120 in which the computing device operates. The remaining columns of the server table 340 describe the computing device by providing the number of CPU cores available, the amount of RAM (in GB), and the power consumption of the computing device.

The format 420 of the data center table 410 includes a data center identifier, a power usage efficiency, a region, and a green power indicator. Each of the rows 430A-430C stores data for a single data center. The data center identifier is a unique identifier for the data center. The power usage efficiency indicates the multiplicative factor to be applied to the power consumption by servers in the data center to determine the total power consumption. Thus, the theoretical minimum power usage efficiency is 1.0, wherein 100% of power consumed is used to power servers in the data center. The green power indicator indicates whether the power consumed by the power center comes from renewable energy sources (e.g., wind or solar power) that do not generate carbon emissions. The region indicator may be cross-referenced with data in the region table 440 to determine the carbon emissions resulting from power consumed by the data center.

The region table 440 identifies the carbon rate for a set of regions. Thus, the row 460A indicates that power generation in Europe averages 399 g of Carbon per kilowatt-hour of power. The row 460B shows that power generation in the United States produces slightly more Carbon, at 411 g/kWh. And the row 460C shows that power generation in India is much more Carbon, at 747 g/kWh.

Data for the usage of the products of the product table 310 is stored in the usage table 470. Each of the rows 490A-490C identifies an account, a cloud-based application provided to the account, a number of users for the cloud-based application, and a load for the cloud-based application. Based on the information in the usage table 470 and the product table 310, a number of CPU cores and an amount of RAM to be used to provide the cloud-based application to the account may be determined.

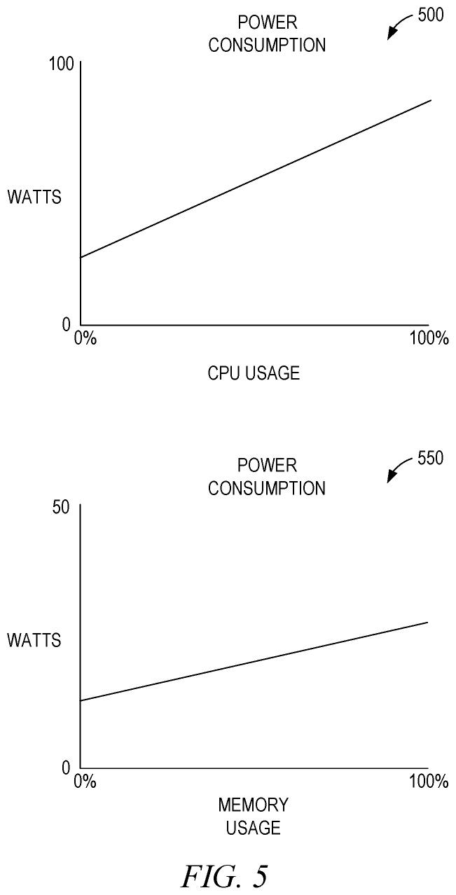

FIG. 5 illustrates graphs 500 and 550 of power consumption for a server as a function of CPU and memory usage, suitable for use in carbon footprint sizing cloud solutions according to some example embodiments. The graph 500 shows that power consumption for a server varies as a linear function of CPU usage. The graph 550 shows that power consumption for the server varies as a linear function of memory usage. Total power consumption for the server may be determined by adding the power consumption for each component of the server.

In the example of FIG. 5, the power consumption of the server based on the two variables of CPU usage and memory usage is determined independently for each variable and then summed. In other examples, the power consumption of the server may be determined based on multiple variables simultaneously. For example, the power consumption at high CPU load and high memory usage may be higher or lower than the power consumption at high CPU load with minimal memory usage summed with the power consumption at high memory usage with minimal CPU load.

By the use of the graphs 500 and 550, power consumption for a server may be determined as a function of usage rather than as a fixed value, allowing for a finer-grained determination of power consumption for a cloud-based application. For example, if the servers 1 and 2 from the server table 340 of FIG. 3 are assigned to an account of a cloud-based application, the total power consumption of 350 W may be used in determining the carbon footprint for the account. Alternatively, the graphs 500 and 550, customized for the servers 1 and 2, may be used to determine a fraction of the maximum power consumption for each server that is actually used when providing the application.

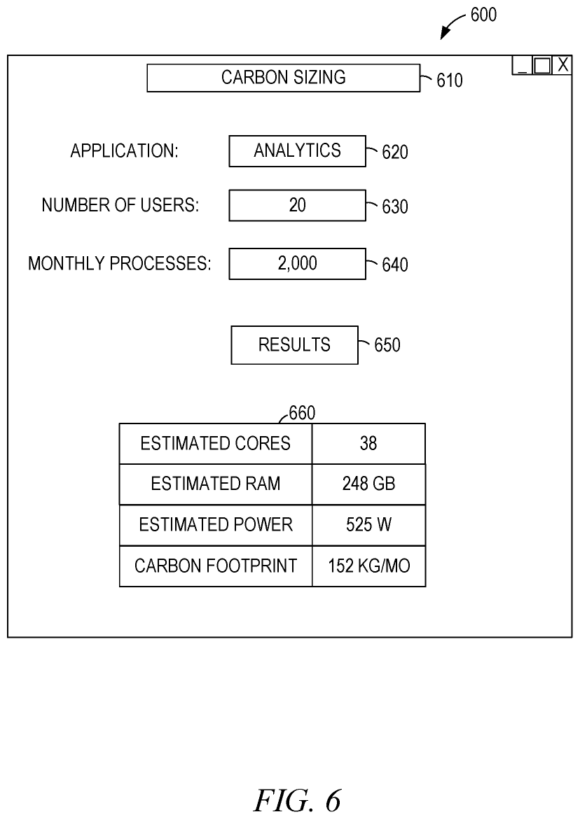

FIG. 6 is a block diagram of a user interface 600 suitable for carbon footprint sizing cloud solutions, according to some example embodiments. The user interface 600 includes a title 610, an application field 620, a number of users field 630, a monthly processes field 640, a button 650, and carbon footprint data 660. The user interface 600 may be generated by the carbon footprint server 150 and presented on a display of a client device 160, both shown in FIG. 1.

The title 610 indicates that the user interface 600 is for carbon footprint sizing. The application field 620 indicates that the cloud-based solution being sized is an analytics application. The application field 620 may be operable to select an application from a set of applications (e.g., the applications identified in the product table 310 of FIG. 3).

The number of users field 630 may be operable to receive a user input indicating the number of users for the application indicated in the application field 620. Alternatively, the number of users field 630 may be populated with data from the usage table 470 of FIG. 4. Similarly, the monthly processes field 640 may receive a user input indicating the number of processes for the application or the value may be populated with data from the usage table 470. Input received in the fields 630-640 may be used to update the usage table 470.

The button 650 may be operable to cause the determination of a carbon footprint for the application indicated in the application field 620 based on the data in the number of users field 630 and the monthly processes field 640. In response to operation of the button 650, the carbon footprint data 660 may be displayed. In the example of FIG. 6, the carbon footprint data 660 includes an estimated number of CPU cores to be used to provide the cloud-based application to an account, an estimated amount of RAM to be used to provide the cloud-based application to the account, an estimated amount of power consumed by computing devices providing the cloud-based application to the account, and an estimated carbon footprint of providing the cloud-based application to the account. The carbon footprint may be shown in terms of an amount of carbon generation per time period (e.g., per month, per year, or per day), per user, per process, or any suitable combination thereof.

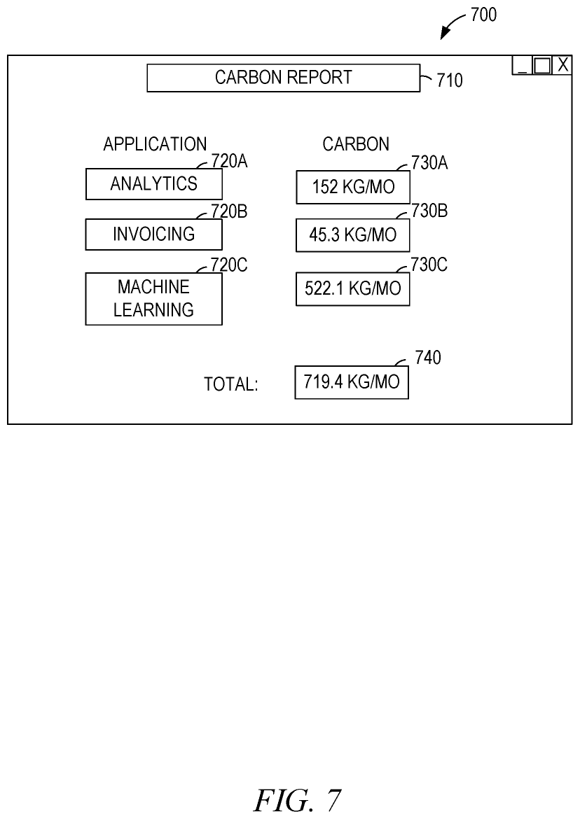

FIG. 7 is a block diagram of a user interface 700 suitable for carbon footprint sizing cloud solutions, according to some example embodiments. The user interface 700 includes a title 710, application fields 720A, 720B, and 720C, per-application carbon footprint fields 730A, 730B, and 730C, and a total carbon footprint field 740. The user interface 700 may be generated by the carbon footprint server 150 and presented on a display of a client device 160, both shown in FIG. 1.

The title 710 indicates that the user interface 700 is for a carbon report. The application fields 720A-720C indicate which application the carbon footprint data in the carbon footprint fields 730A-730C is for. Thus, in the example of FIG. 7, an analytics application is generating 152 kg/month of carbon, an invoicing application is generating 45.3 kg/month, and a machine learning application is generating 522.1 kg/month. Data used to determine the carbon footprints may have been received in the user interface 600 of FIG. 6, accessed from a database server 140 using the database schema 300 of FIGS. 3-4, or any suitable combination thereof. The total carbon footprint field 740 indicates the sum of the carbon footprints in the carbon footprint fields 730A-730C. Thus, by use of the user interface 700, a user is enabled to see the carbon footprint associated with each of a plurality of cloud-based applications being provided to an account, as well as the total carbon footprint of all of the cloud-based applications for the account.

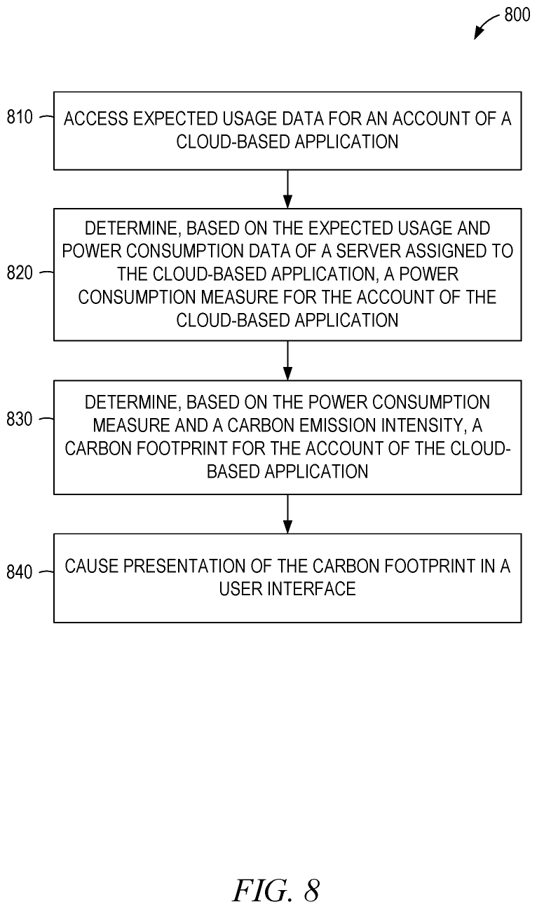

FIG. 8 is a flowchart illustrating operations of a method 800 suitable for carbon footprint sizing cloud solutions, according to some example embodiments. The method 800 includes operations 810, 820, 830, and 840. By way of example and not limitation, the method 800 may be performed by the carbon footprint server 150 of FIG. 1, using the modules, databases, and user interfaces shown in FIGS. 2-7.

In operation 810, the computing requirement module 220 (of FIG. 2) of the carbon footprint server 150 (of FIG. 1) accesses expected usage data for an account of a cloud-based application. For example, the row 490A of the usage table 470 of FIG. 4 may be accessed, indicating that account 1 has 20 users and a load of 2,000 for product 1. Furthermore, cross-referencing the product identifier with the product table 310 of FIG. 3 shows that the usage data of the row 490A is for the product “Analytics.”

Based on the expected usage data of the row 490A and the product data of the row 330A for the “Analytics” product, the computing resources consumed in providing the cloud-based application to the account may be determined. For example, the number of CPU cores may be determined as follows:

Base CPU+(User CPU)(Number of Users)+(Load CPU)(Load).

Similarly, the amount of RAM may be determined as follows:

Base RAM+(User RAM)(Number of Users)+(Load RAM)(Load).

In this example, the Base CPU is 16, the Base RAM is 128 GB, the User CPU is 0.1, the User RAM is 4 GB, the Load CPU is 0.01, the Load RAM is 0.02 (all from the row 330A), the Number of Users is 20, and the Load is 2,000 (both from the row 490A). Thus, the number of CPU cores is 16+(0.1) (20)+(0.01) (2,000)=38 cores. The amount of RAM is 128+(4) (20)+(0.02) (2,000)=248 GB.

The resource consumption data may be used with the data in the server table 340 to assign one or more servers, in whole or in part, to providing the cloud-based application to the account. For example, the rows 360A-360B show that servers 1 and 2, combined, have 38 cores and 4096 GB of RAM. Thus, assigning those two servers to the task of providing the “Analytics” application to account 1 is sufficient to meet the account's expected usage.

Additional details regarding the resource consumption of the cloud-based application for the account may be determined. For example, a number of memory accesses per second, a percentage of CPU utilization, an amount of data sent or received via a network, or any suitable combination thereof may be determined and used to determine the power consumption of the cloud-based application for the account.

The energy consumption module 230, in operation 820, determines, based on the expected usage and power consumption data of a server assigned to the cloud-based application, a power consumption measure for the account of the cloud-based application. Continuing with this example, all cores of servers 1 and 2 are used to provide the application to the account. The rows 360A and 360B indicate that the two servers use 150 W and 200 W of power, respectively. Accordingly, the total power consumption by the servers in providing the cloud-based application to the account is 350 W.

To account for power consumption in providing computing services outside of the power consumed by the servers themselves, the power usage efficiency data in the data center table 410 may be used by the efficiency module 240. For example, servers 1 and 2 are both located in data center 1 (as shown in the rows 360A and 360B). Data center 1 has a power usage efficiency of 1.5. The 350 W consumed by the servers themselves is multiplied by the power usage efficiency of the data center to determine that 525 W of power are consumed to provide the cloud-based application to the account.

In some example embodiments, the power usage efficiency used by the efficiency module 240 for the data center is a global average power usage efficiency used for all data centers in the world. In other example embodiments, the power usage efficiency used by the efficiency module 240 for the data center is a national average power usage efficiency used for all data centers within a country, with different power usage efficiencies being used in different countries. The power usage efficiencies for larger regions may be used as fallback positions. For example, if a power usage efficiency for a data center is available, the power usage efficiency for the data center is used. If the power usage efficiency for the data center is not available, but a power usage efficiency for the country of the data center is available, the power usage efficiency for the country is used. If the power usage efficiency for the country of the data center is also not available, a global power usage efficiency is used. The national and global power usage efficiencies may be accessed from a database.

In operation 830, the carbon footprint module 250 determines, based on the power consumption measure and a carbon emission intensity, a carbon footprint for the account of the cloud-based application. For example, the row 430A indicates that the data center 1 is located in Europe. The region table 440 indicates that power generation in Europe generates an average of 399 g/kWh of carbon. The rate of carbon generation may be determined by multiplying the power consumption by the carbon emission intensity. Thus, (0.525 kW) (399 g/kWh)=209 g/h and 209 g of carbon are generated per hour in providing the cloud-based application to the account. The carbon emission rate can be converted to an amount of carbon by multiplying by a period of time. For example, the 209 g/h may be multiplied by the 730 hours in a typical month to determine a monthly emissions of 152 kg of carbon.

The user interface module 260, in operation 840, causes presentation of the carbon footprint in a user interface. For example, the user interface 600 of FIG. 6 or the user interface 700 of FIG. 7 may be presented. Thus, by use of the method 800, a user of an account is enabled to determine the carbon footprint for a cloud-based application. The method 800 may be repeated for multiple cloud-based applications of the account to allow the user to determine the total carbon footprint for the multiple cloud-based applications.

In view of the above described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a method comprising: accessing, by one or more processors, expected usage data for an account of a cloud-based application; determining, by the one or more processors and based on the expected usage and power consumption data of a server assigned to the cloud-based application, a power consumption measure for the account of the cloud-based application; determining, by the one or more processors and based on the power consumption measure and a carbon emission intensity, a carbon footprint for the account of the cloud-based application; and causing presentation of the carbon footprint in a user interface.

In Example 2, the subject matter of Example 1, wherein the determining of the carbon footprint is further based on a power usage efficiency for a data center housing the server.

In Example 3, the subject matter of Example 2, wherein the power usage efficiency for the data center is a global average power usage efficiency.

In Example 4, the subject matter of Examples 2-3, wherein the power usage efficiency for the data center is a national average power usage efficiency.

In Example 5, the subject matter of Examples 1-4, wherein the determining of the power consumption measure comprises: determining a number of central processing unit (CPU) cores that will be used by the account of the cloud-based application.

In Example 6, the subject matter of Example 5, wherein the determining of the power consumption measure comprises: determining an average percentage of CPU loading that will be used by the account of the cloud-based application.

In Example 7, the subject matter of Examples 1-6, wherein the determining of the power consumption measure comprises: determining an amount of memory that will be used by the account of the cloud-based application.

In Example 8, the subject matter of Examples 1-7, wherein the accessing of the expected usage data comprises: accessing a number of users for the account that will use the cloud-based application.

In Example 9, the subject matter of Examples 1-8, wherein the accessing of the expected usage data comprises: accessing a load for the account that will be processed by the cloud-based application.

In Example 10, the subject matter of Examples 1-9 includes accessing second expected usage data for the account of a second cloud-based application; determining, based on the power consumption measure and the carbon emission intensity, a second carbon footprint for the account of the second cloud-based application; and determining, based on the first carbon footprint and the second carbon footprint, a total carbon footprint for the account; wherein the user interface comprises the second carbon footprint and the total carbon footprint.

Example 11 is a system comprising: a memory that stores instructions; and one or more processors configured by the instructions to perform operations comprising: accessing expected usage data for an account of a cloud-based application; determining, based on the expected usage and power consumption data of a server assigned to the cloud-based application, a power consumption measure for the account of the cloud-based application; determining, based on the power consumption measure and a carbon emission intensity, a carbon footprint for the account of the cloud-based application; and causing presentation of the carbon footprint in a user interface.

In Example 12, the subject matter of Example 11, wherein the determining of the carbon footprint is further based on a power usage efficiency for a data center housing the server.

In Example 13, the subject matter of Example 12, wherein the power usage efficiency for the data center is a global average power usage efficiency.

In Example 14, the subject matter of Examples 12-13, wherein the power usage efficiency for the data center is a national average power usage efficiency.

In Example 15, the subject matter of Examples 11-14, wherein the determining of the power consumption measure comprises: determining a number of central processing unit (CPU) cores that will be used by the account of the cloud-based application.

In Example 16, the subject matter of Example 15, wherein the determining of the power consumption measure comprises: determining an average percentage of CPU loading that will be used by the account of the cloud-based application.

In Example 17, the subject matter of Examples 11-16, wherein the determining of the power consumption measure comprises: determining an amount of memory that will be used by the account of the cloud-based application.

Example 18 is a non-transitory computer-readable medium that stores instructions that, when executed by one or more processors, cause the one or more processors to perform operations comprising: accessing expected usage data for an account of a cloud-based application; determining, based on the expected usage and power consumption data of a server assigned to the cloud-based application, a power consumption measure for the account of the cloud-based application; determining, based on the power consumption measure and a carbon emission intensity, a carbon footprint for the account of the cloud-based application; and causing presentation of the carbon footprint in a user interface.

In Example 19, the subject matter of Example 18, wherein the accessing of the expected usage data comprises: accessing a number of users for the account that will use the cloud-based application.

In Example 20, the subject matter of Examples 18-19, wherein the accessing of the expected usage data comprises: accessing a load for the account that will be processed by the cloud-based application.

Example 21 is at least one machine-readable medium including instructions that, when executed by processing circuitry, cause the processing circuitry to perform operations to implement any of Examples 1-20.

Example 22 is an apparatus comprising means to implement any of Examples 1-20.

Example 23 is a system to implement any of Examples 1-20.

Example 24 is a method to implement any of Examples 1-20.

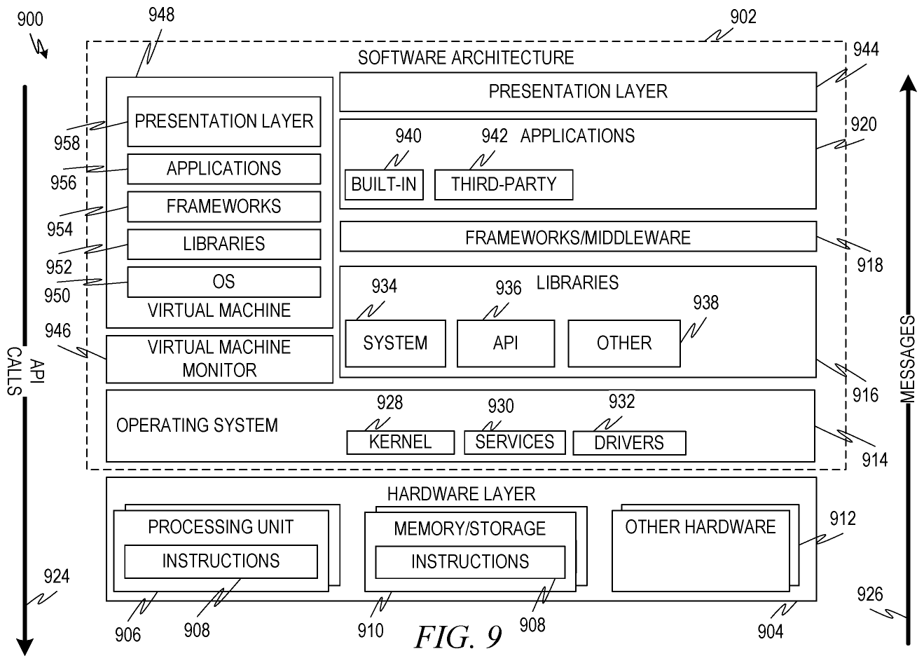

FIG. 9 is a block diagram 900 showing one example of a software architecture 902 for a computing device. The software architecture 902 may be used in conjunction with various hardware architectures, for example, as described herein. FIG. 9 is merely a non-limiting example of a software architecture and many other architectures may be implemented to facilitate the functionality described herein. A representative hardware layer 904 is illustrated and can represent, for example, any of the above referenced computing devices. In some examples, the hardware layer 904 may be implemented according to the architecture of the computer system of FIG. 9.

The representative hardware layer 904 comprises one or more processing units 906 having associated executable instructions 908. Executable instructions 908 represent the executable instructions of the software architecture 902, including implementation of the methods, modules, subsystems, and components, and so forth described herein and may also include memory and/or storage modules 910, which also have executable instructions 908. Hardware layer 904 may also comprise other hardware as indicated by other hardware 912 which represents any other hardware of the hardware layer 904, such as the other hardware illustrated as part of the software architecture 902.

In the example architecture of FIG. 9, the software architecture 902 may be conceptualized as a stack of layers where each layer provides particular functionality. For example, the software architecture 902 may include layers such as an operating system 914, libraries 916, frameworks/middleware layer 918, applications 920, and presentation layer 944. Operationally, the applications 920 and/or other components within the layers may invoke application programming interface (API) calls 924 through the software stack and access a response, returned values, and so forth illustrated as messages 926 in response to the API calls 924. The layers illustrated are representative in nature and not all software architectures have all layers. For example, some mobile or special purpose operating systems may not provide a frameworks/middleware layer 918, while others may provide such a layer. Other software architectures may include additional or different layers.

The operating system 914 may manage hardware resources and provide common services. The operating system 914 may include, for example, a kernel 928, services 930, and drivers 932. The kernel 928 may act as an abstraction layer between the hardware and the other software layers. For example, the kernel 928 may be responsible for memory management, processor management (e.g., scheduling), component management, networking, security settings, and so on. The services 930 may provide other common services for the other software layers. In some examples, the services 930 include an interrupt service. The interrupt service may detect the receipt of an interrupt and, in response, cause the software architecture 902 to pause its current processing and execute an interrupt service routine (ISR) when an interrupt is accessed.

The drivers 932 may be responsible for controlling or interfacing with the underlying hardware. For instance, the drivers 932 may include display drivers, camera drivers, Bluetooth® drivers, flash memory drivers, serial communication drivers (e.g., Universal Serial Bus (USB) drivers), Wi-Fi® drivers, near-field communication (NFC) drivers, audio drivers, power management drivers, and so forth depending on the hardware configuration.

The libraries 916 may provide a common infrastructure that may be utilized by the applications 920 and/or other components and/or layers. The libraries 916 typically provide functionality that allows other software modules to perform tasks in an easier fashion than to interface directly with the underlying operating system 914 functionality (e.g., kernel 928, services 930 and/or drivers 932). The libraries 916 may include system libraries 934 (e.g., C standard library) that may provide functions such as memory allocation functions, string manipulation functions, mathematic functions, and the like. In addition, the libraries 916 may include API libraries 936 such as media libraries (e.g., libraries to support presentation and manipulation of various media format such as MPEG4, H.264, MP3, AAC, AMR, JPG, PNG), graphics libraries (e.g., an OpenGL framework that may be used to render two-dimensional and three-dimensional in a graphic content on a display), database libraries (e.g., SQLite that may provide various relational database functions), web libraries (e.g., WebKit that may provide web browsing functionality), and the like. The libraries 916 may also include a wide variety of other libraries 938 to provide many other APIs to the applications 920 and other software components/modules.

The frameworks/middleware layer 918 may provide a higher-level common infrastructure that may be utilized by the applications 920 and/or other software components/modules. For example, the frameworks/middleware layer 918 may provide various graphic user interface (GUI) functions, high-level resource management, high-level location services, and so forth. The frameworks/middleware layer 918 may provide a broad spectrum of other APIs that may be utilized by the applications 920 and/or other software components/modules, some of which may be specific to a particular operating system or platform.

The applications 920 include built-in applications 940 and/or third-party applications 942. Examples of representative built-in applications 940 may include, but are not limited to, a contacts application, a browser application, a book reader application, a location application, a media application, a messaging application, and/or a game application. Third-party applications 942 may include any of the built-in applications as well as a broad assortment of other applications. In a specific example, the third-party application 942 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 942 may invoke the API calls 924 provided by the mobile operating system such as operating system 914 to facilitate functionality described herein.

The applications 920 may utilize built in operating system functions (e.g., kernel 928, services 930 and/or drivers 932), libraries (e.g., system libraries 934, API libraries 936, and other libraries 938), and frameworks/middleware layer 918 to create user interfaces to interact with users of the system. Alternatively, or additionally, in some systems, interactions with a user may occur through a presentation layer, such as presentation layer 944. In these systems, the application/module “logic” can be separated from the aspects of the application/module that interact with a user.

Some software architectures utilize virtual machines. In the example of FIG. 9, this is illustrated by virtual machine 948. A virtual machine creates a software environment where applications/modules can execute as if they were executing on a hardware computing device. A virtual machine is hosted by a host operating system (operating system 914) and typically, although not always, has a virtual machine monitor 946, which manages the operation of the virtual machine as well as the interface with the host operating system (i.e., operating system 914). A software architecture executes within the virtual machine 948 such as an operating system 950, libraries 952, frameworks/middleware 954, applications 956 and/or presentation layer 958. These layers of software architecture executing within the virtual machine 948 can be the same as corresponding layers previously described or may be different.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is a tangible unit capable of performing certain operations and may be configured or arranged in a certain manner. In example embodiments, one or more computer systems (e.g., a standalone, client, or server computer system) or one or more hardware processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or another programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired), or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses that connect the hardware-implemented modules). In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment, or a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., APIs).

### Electronic Apparatus and System

Example embodiments may be implemented in digital electronic circuitry, or in computer hardware, firmware, or software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a standalone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., an FPGA or an ASIC.

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or in a combination of permanently and temporarily configured hardware may be a design choice. Below are set out hardware (e.g., machine) and software architectures that may be deployed, in various example embodiments.

### Example Machine Architecture and Machine-Readable Medium

FIG. 10 is a block diagram of a machine in the example form of a computer system 1000 within which instructions 1024 may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch, or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU), or both), a main memory 1004, and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard or a touch-sensitive display screen), a user interface (UI) navigation (or cursor control) device 1014 (e.g., a mouse), a storage unit 1016, a signal generation device 1018 (e.g., a speaker), and a network interface device 1020.

### Machine-Readable Medium

The storage unit 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004 and/or within the processor 1002 during execution thereof by the computer system 1000, with the main memory 1004 and the processor 1002 also constituting machine-readable media 1022.

While the machine-readable medium 1022 is shown in an example embodiment to be a single medium, the term “machine-readable medium” may include a single medium or multiple media (e.g., a centralized or distributed database, and/or associated caches and servers) that store the one or more instructions 1024 or data structures. The term “machine-readable medium” shall also be taken to include any tangible medium that is capable of storing, encoding, or carrying instructions 1024 for execution by the machine and that cause the machine to perform any one or more of the methodologies of the present disclosure, or that is capable of storing, encoding, or carrying data structures utilized by or associated with such instructions 1024. The term “machine-readable medium” shall accordingly be taken to include, but not be limited to, solid-state memories, and optical and magnetic media. Specific examples of machine-readable media 1022 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and compact disc read-only memory (CD-ROM) and digital versatile disc read-only memory (DVD-ROM) disks. A machine-readable medium is not a transmission medium.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., hypertext transport protocol (HTTP)). Examples of communication networks include a local area network (LAN), a wide area network (WAN), the Internet, mobile telephone networks, plain old telephone (POTS) networks, and wireless data networks (e.g., WiFi and WiMax networks). The term “transmission medium” shall be taken to include any intangible medium that is capable of storing, encoding, or carrying instructions 1024 for execution by the machine, and includes digital or analog communications signals or other intangible media to facilitate communication of such software.

Although specific example embodiments are described herein, it will be evident that various modifications and changes may be made to these embodiments without departing from the broader spirit and scope of the disclosure. Accordingly, the specification and drawings are to be regarded in an illustrative rather than a restrictive sense. The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

Some portions of the subject matter discussed herein may be presented in terms of algorithms or symbolic representations of operations on data stored as bits or binary digital signals within a machine memory (e.g., a computer memory). Such algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or any suitable combination thereof), registers, or other machine components that receive, store, transmit, or display information. Furthermore, unless specifically stated otherwise, the terms “a” and “an” are herein used, as is common in patent documents, to include one or more than one instance. Finally, as used herein, the conjunction “or” refers to a non-exclusive “or,” unless specifically stated otherwise.

What is claimed is:

1. A method comprising:
accessing, by one or more processors, expected usage data for an account of a cloud-based application;
determining, by the one or more processors and based on the expected usage and power consumption data of a server assigned to the cloud-based application, a power consumption measure for the account of the cloud-based application;
determining, by the one or more processors and based on the power consumption measure and a carbon emission intensity, a carbon footprint for the account of the cloud-based application; and
causing presentation of the carbon footprint in a user interface.

2. The method of claim 1, wherein the determining of the carbon footprint is further based on a power usage efficiency for a data center housing the server.

3. The method of claim 2, wherein the power usage efficiency for the data center is a global average power usage efficiency.

4. The method of claim 2, wherein the power usage efficiency for the data center is a national average power usage efficiency.

5. The method of claim 1, wherein the determining of the power consumption measure comprises:
determining a number of central processing unit (CPU) cores that will be used by the account of the cloud-based application.

6. The method of claim 5, wherein the determining of the power consumption measure comprises:
determining an average percentage of CPU loading that will be used by the account of the cloud-based application.

7. The method of claim 1, wherein the determining of the power consumption measure comprises:
determining an amount of memory that will be used by the account of the cloud-based application.

8. The method of claim 1, wherein the accessing of the expected usage data comprises:
accessing a number of users for the account that will use the cloud-based application.

9. The method of claim 1, wherein the accessing of the expected usage data comprises:
accessing a load for the account that will be processed by the cloud-based application.

10. The method of claim 1, further comprising:
accessing second expected usage data for the account of a second cloud-based application;
determining, based on the power consumption measure and the carbon emission intensity, a second carbon footprint for the account of the second cloud-based application; and
determining, based on the first carbon footprint and the second carbon footprint, a total carbon footprint for the account;
wherein the user interface comprises the second carbon footprint and the total carbon footprint.

11. A system comprising:
a memory that stores instructions; and
one or more processors configured by instructions to perform operations comprising:
accessing expected usage data for an account of a cloud-based application;
determining, based on the expected usage and power consumption data of a server assigned to the cloud-based application, a power consumption measure for the account of the cloud-based application;
determining, based on the power consumption measure and a carbon emission intensity, a carbon footprint for the account of the cloud-based application; and
causing presentation of the carbon footprint in a user interface.

12. The system of claim 11, wherein the determining of the carbon footprint is further based on a power usage efficiency for a data center housing the server.

13. The system of claim 12, wherein the power usage efficiency for the data center is a global average power usage efficiency.

14. The system of claim 12, wherein the power usage efficiency for the data center is a national average power usage efficiency.

15. The system of claim 11, wherein the determining of the power consumption measure comprises:
determining a number of central processing unit (CPU) cores that will be used by the account of the cloud-based application.

16. The system of claim 15, wherein the determining of the power consumption measure comprises:
determining an average percentage of CPU loading that will be used by the account of the cloud-based application.

17. The system of claim 11, wherein the determining of the power consumption measure comprises:
determining an amount of memory that will be used by the account of the cloud-based application.

18. A non-transitory computer-readable medium that stores instructions that, when executed by one or more processors, cause the one or more processors to perform operations comprising:
accessing expected usage data for an account of a cloud-based application;
determining, based on the expected usage and power consumption data of a server assigned to the cloud-based application, a power consumption measure for the account of the cloud-based application;
determining, based on the power consumption measure and a carbon emission intensity, a carbon footprint for the account of the cloud-based application; and
causing presentation of the carbon footprint in a user interface.

19. The non-transitory computer-readable medium of claim 18, wherein the accessing of the expected usage data comprises:
accessing a number of users for the account that will use the cloud-based application.

20. The non-transitory computer-readable medium of claim 18, wherein the accessing of the expected usage data comprises:
accessing a load for the account that will be processed by the cloud-based application.
